(19) United States
(12) Patent Application Publication
(10) Pub. No.: US 2025/0093037 A1
(43) Pub. Date: Mar. 20, 2025

(54) CLEAN COMBUSTION STOVE

(71) Applicants: Sophie Rose Goldberg, Hanover, NH (US); Alda Zeneli, Hanover, NH (US); Margaret Eleanor Frazier, Manchester, MD (US); Sara Magdalena Gómez, Hanover, NH (US); Abigail Catherine Hughes, Hanover, NH (US)

(72) Inventors: Sophie Rose Goldberg, Hanover, NH (US); Alda Zeneli, Hanover, NH (US); Margaret Eleanor Frazier, Manchester, MD (US); Sara Magdalena Gómez, Hanover, NH (US); Abigail Catherine Hughes, Hanover, NH (US)

(21) Appl. No.: 18/883,863

(22) Filed: Sep. 12, 2024

Related U.S. Application Data
(60) Provisional application No. 63/583,066, filed on Sep. 15, 2023.

(51) Int. Cl. F24B 5/02; F24B 1/26

(52) U.S. Cl. CPC F24B 5/025; F24B 1/26; F24B 5/023

(57) ABSTRACT

A clean combustion stove is described herein. The clean combustion stove may include a tapered heating chamber further including a primary combustion zone and a secondary combustion zone. The primary combustion zone, in a lower portion of the tapered heating chamber, may include a grate configured to support a fuel source and a first set of intake elements configured to intake air from outside of the tapered heating chamber, fueling primary combustion of the fuel source, which may produce smoke. The secondary combustion zone, in an upper portion of the tapered heating chamber, above the primary combustion zone, may include a second set of air intake elements connected to a circulation tube via one or more intake tubes. The second set of intake elements may be configured to intake air from outside of the tapered heating chamber, fueling secondary combustion of the fuel source, which may eliminate the smoke.

### FIELD OF TECHNOLOGY

The present application for patent claims the benefit of U.S. Provisional Patent Application No. 63/583,066 by GOLDBERG et al., entitled “CLEAN COMBUSTION STOVE,” filed Sep. 15, 2023, assigned to the assignee hereof, and expressly incorporated by reference herein

### FIELD OF TECHNOLOGY

The following relates to cooking devices, including clean combustion stoves.

### BACKGROUND

Some cooking devices may support cooking via open fires in which a fuel source is ignited to produce a fire at least partially exposed to an environment. However, cooking via open fires may result in the production of smoke, which may be inhaled by users of the cooking device, negatively impacting health of the users.

### BRIEF DESCRIPTION OF THE DRAWINGS

FIG. 1 illustrates an example of a clean combustion stove that supports clean combustion in accordance with aspects of the present disclosure.

FIG. 2 illustrates an example of a block diagram of a clean combustion stove that supports clean combustion in accordance with aspects of the present disclosure.

### DETAILED DESCRIPTION

Some cooking devices may support cooking via open fires. That is, a fuel source, such as wood, coal, gas, or the like thereof, may be placed or fed into a cooking device and ignited, or combusted, such that a fire is produced and is open to the environment. However, the cooking device may produce smoke via incomplete combustion of the fuel source. That is, a first portion of the fuel source may be combusted to produce heat while a second portion of the fuel source may be released into the air, in the form of smoke. Due to the open nature of the fires produced by the cooking device, a user of the cooking device may be exposed to the smoke and may inhale the smoke into their lungs, which may negatively impact the health of the user. Specifically, users who operate the cooking device for an extended period of time may experience significant exposure to the smoke, which may have detrimental impacts on the health of the users.

Accordingly, devices described herein may support clean combustion of a fuel source to protect users of the device from negative impacts due to smoke generated from incomplete combustion. That is, a clean combustion stove described herein may support dual combustion of a fuel source to prevent or reduce the production of smoke. For example, the clean combustion stove may include a tapered heating chamber that may direct heat to a centralized output, where the heat directed to the centralized output may be utilized by a user to cook. The clean combustion stove may further include a grate, located at a bottom of the clean combustion stove, that may support, or hold, a fuel source, such as wood, coals, or the like thereof. A first set of intake elements positioned through a wall of the tapered heating chamber, below the grate, may intake air from outside of the tapered heating chamber and supply the air into a primary combustion zone in which primary combustion of the fuel source occurs, producing smoke. A second set of intake elements may be located above the primary combustion zone, in a secondary combustion zone, and may intake air from outside of the tapered heating chamber and direct the air through a circulation tub. That is, the second set of intake elements may include one or more intake tubes having a first opening through the wall of the tapered heating chamber and a second opening entering the circulation tube. Further, the circulation tube, positioned within the tapered heating chamber in the secondary combustion zone above the first set of intake elements, may include multiple outlet holes. The multiple outlet holes may direct air from the one or more intake tubes into the secondary combustion zone, such that the smoke produced by the primary combustion may be combusted in the secondary combustion zone. In other words, the fuel source may be combusted a first time in the primary combustion zone (e.g., during primary combustion) and a second time in the secondary combustion zone (e.g., during secondary combustion), which may be referred to as dual combustion. As such, the secondary combustion of the fuel source may reduce a quantity of un-combusted fuel source below a threshold, such that smoke exiting the centralized output is reduced (e.g., below a threshold) or eliminated. As such, a user operating the clean combustion stove may have limited exposure to smoke, reducing the negative impacts on the health of the user.

Aspects of the disclosure are described in the context of a diagram of a clean combustion cooking stove.

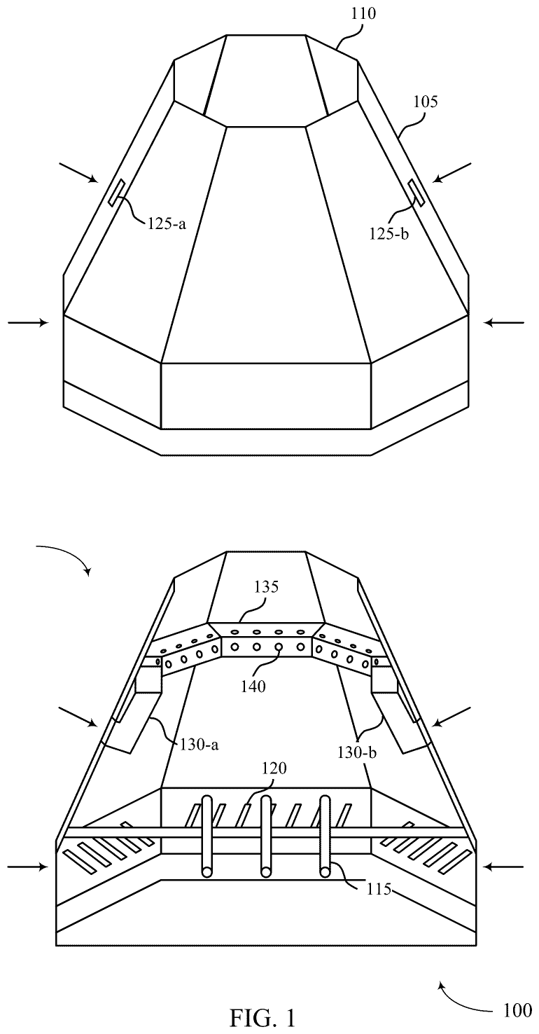

FIG. 1 illustrates an example of a clean combustion stove 100 that supports clean combustion in accordance with aspects of the present disclosure.

Some communities, such as those in impoverished countries, may not have access to electricity and, as such, members of the communities may rely on open fires to cook. That is, a fuel source, such as wood, coal, gas, or the like thereof, may be placed or fed into a cooking device and ignited, or combusted, such that a fire is produced and is open to the environment. However, open fires may produce smoke via incomplete combustion of the fuel source. In other words, a user may ignite the fuel source and heat may be produced via combustion of the fuel source. However, the heat may be produced via combustion of a first portion of the fuel source and a second portion of the fuel source may not be combusted (e.g., may be un-combusted) and may be released into the air, in the form of smoke.

Due to the open nature of the fires, the user may be exposed to the smoke and may inhale the smoke into their lungs, which may negatively impact the health of the user. Specifically, users who cook via open fires may be exposed to the smoke for an extended period of time, which may have detrimental impacts on the health of the users. For example, women in impoverished countries may spend 3 to 6 hours cooking every day via open fires and exposure to smoke during those 3 to 6 hours may be equivalent to inhaling 400 cigarettes worth of smoke.

Accordingly, devices described herein may support clean combustion of a fuel source to protect users of the device from negative impacts due to smoke generated from incomplete combustion. That is, the clean combustion stove 100 described herein may support dual combustion of a fuel source to prevent or reduce the production of smoke. For example, the clean combustion stove 100 may include a tapered heating chamber 105 that may direct heat to a centralized output 110 (e.g., at a top of the tapered heating chamber 105), where the heat directed to the centralized output 110 may be utilized by a user to cook. The tapered heating chamber 105 may be octagonal in shape and a surface area of a base of the tapered heating chamber 105 may be greater than a surface area of a top of the tapered heating chamber 105 (e.g., thus producing a tapered shape), where the top of the tapered heating chamber includes the centralized output 110. The tapered heating chamber 105 may further include multiple walls connecting the base to the top, where the multiple walls include a first set of intake elements 120 and a second set of intake elements 130, described in further detail below.

Additionally, the tapered heating chamber 105 may include a door (e.g., not shown) that may be opened and closed to access a fuel source, as well as a base tray, or ash tray (e.g., not shown), that may include the base of the tapered heating chamber 105 and may be removable, such that waste produced by the fuel source may be accessed by the user. Additionally, the clean combustion stove 100 may further include a grate 115, located at a bottom of the clean combustion stove 100, that may support, or hold, a fuel source, such as wood, coals, or the like thereof. The grate 115 may be located above the first set of intake elements 120. In some cases, as depicted in FIG. 1, the grate 115 may include a first bar (e.g., cylindrical bar) in a first direction, intersected but multiple second bars in a second direction, where the second direction is perpendicular to the first direction and the first bar is longer than the multiple second bars. In some other cases (e.g., not depicted), the grate 115 may include multiple (e.g., 2) first bars in the first direction, intersected by the multiple second bars in the second direction. Though described in the context of first and second bars, this is not to be regarded as a limitation of the present disclosure, as any design of the grate 115 (e.g., any quantity or size of first bars, any quantity or size of second bars) may be considered with regards to the techniques described herein.

The first set of intake elements 120 positioned through one or more of the walls of the tapered heating chamber 105, below the grate 115, may intake air from outside of the tapered heating chamber 105. In some examples, the first set of intake elements 120 may be positioned through a subset of the walls of the tapered heating chamber 105. Additionally, the first set of intake elements 120 may be positioned in a primary combustion zone. The primary combustion zone may include a lower portion of the tapered heating chamber 105 where primary, or first, combustion of the fuel source may occur, producing smoke. That is, the fuel source may be placed on the grate 115 and may be ignited (e.g., via application of a flame, or heat) creating a fire, such that the primary combustion of the fuel source based on the ignition may produce a negative pressure that may draw air through the first set of intake elements 120, fueling the fire. In some examples, one or more of the first set of intake elements 120 may be covered to increase or decrease a first rate associated with the primary combustion (e.g., how strongly the fire burns). The primary combustion may combust a first portion of the fuel source, such that a second portion of the fuel source is released into a secondary combustion zone (e.g., described in further detail below) of the clean combustion stove 100, in the form of smoke.

The secondary combustion zone, located above the primary combustion zone, in an upper portion of the tapered heating chamber 105, may include the second set of intake elements 130, including at least an intake element 130-a and an intake element 130-b. The second set of intake elements 130 may intake air from outside of the tapered heating chamber 105 and direct the air through a circulation tube 135. That is, the second set of intake elements 130 may include one or more intake tubes, including at least a first intake tube and a second intake tube. Each intake tube may have an opening 125 through a wall of the tapered heating chamber 105 and a second opening entering (e.g., connected to) the circulation tube 135. For example, the intake element 130-a may include the first intake tube and an opening 125-a and the intake element 130-b may include the second intake tube and an opening 125-b.

The second set of intake elements 130 may be located below the circulation tube 135, such that the second set of intake elements 130 may intake air at a second rate associated with second combustion of the fuel source. That is, the one or more intake tubes may be heated by the fire, such that a convection current is created in the one or more intake tubes, where the convection current draws, or pulls, air from outside of the tapered heating chamber 105 into the circulation tube 135 via the second set of intake elements 130 (e.g., due to the negative pressure from the primary combustion).

The air drawn into the secondary combustion zone of the tapered heating chamber 105 via the second set of intake elements 130 (e.g., including the intake tubes and openings 125) may be directed into the second combustion zone via one or more outlet holes 140 in the circulation tube 135. That is, the circulation tube 135 may be positioned within the tapered heating chamber 105 in the second combustion zone (e.g., above the first set of intake elements 120 and the second set of intake elements 130) and, in some cases, may extend (e.g., wrap) radially around at least a portion of an inner circumference (e.g., inner surface) of the tapered heating chamber 105. Further, the circulation tube 135 may include the one or more outlet holes 140 that may direct the air from the circulation tube 135 (e.g., further from the second set of intake elements 130) into the secondary combustion zone at the second rate associated with second combustion of the fuel source.

Intaking air at the second rate may enable second combustion of the fuel source in the secondary combustion zone. In other words, as described previously, smoke may be produced via primary combustion of the first portion of fuel source in the primary combustion zone, where the smoke includes a second, un-combusted portion of the fuel source. As such, the second portion of the fuel source may be combusted in the secondary combustion zone. The secondary combustion may combust a quantity of the second portion of the fuel source that satisfies a threshold, such that smoke exiting the centralized output is reduced (e.g., below a threshold) or eliminated. In other words, a quantity of un-combusted fuel source after second combustion may be less than a threshold quantity. The primary combustion and the secondary combustion may collectively be referred to as dual combustion. Further, dual combustion resulting in no smoke production, or smoke production below the threshold, may be referred to as clean combustion.

In some examples, a combined surface area of the one or more outlet holes 140 may be equal to (e.g., within a threshold tolerance of) a surface area of the centralized output 110 to enable secondary combustion. In other words, if the combined surface area of the one or more outlet holes 140 is less than the surface area of the centralized output, too little air (e.g., a quantity of air less than a first threshold quantity) may be drawn into the secondary combustion zone via the second set of intake elements 130, resulting in smoke production from the secondary combustion (e.g., a subset of the second portion of the fuel source may be un-combusted and released in the form of smoke). Conversely, if the combined surface area of the one or more outlet holes 140 is greater than the surface area of the centralized output, a bottleneck may be created in the secondary combustion zone. In other words, too much air (e.g., a quantity of air exceeding a second threshold quantity) may be drawn into the secondary combustion zone via the second set of intake elements 130, resulting in an increase in pressure in the tapered heating chamber 105, which may result in air being pushed out of at least a subset of the second set of intake elements 130. Additionally, or alternatively, air intake via the second set of intake elements 130 may be pushed down into the primary combustion zone, which may extinguish the fire, stopping the primary combustion. As such, the combined surface area of the one or more outlet holes 140 may be equal to a surface area of the centralized output 110 (e.g., be within a threshold range of the surface area of the centralized output 110) to enable regulation of a quantity of air through the second set of intake elements 130 to support the secondary combustion.

In some examples, the clean combustion stove 100 may include a cooking attachment (e.g., not shown). The cooking attachment may be secured on top of the tapered heating chamber 105, at least partially above the centralized output 110. Further, the cooking attachment may enable a cooking apparatus, such as a pot or pan, to be place on top of the clean combustion stove 100 (e.g., attached or secured to the tapered heating chamber 105) in a path of the directed heat, to enable food or liquids in the cooking apparatus to be cooked.

Additionally, or alternatively, the clean combustion stove 100 may include an insulated sleeve (e.g., not shown). The insulated sleeve may be external to the tapered heating chamber 105 and, in some cases, may wrap around the tapered heating chamber 105, to reduce heat loss through the one or more walls of the tapered heating chamber 105. Additionally, or alternatively, the insulated sleeve may prevent or reduce a risk of a user burning themselves on the tapered heating chamber 105. In other words, a material of the insulated sleeve may be associated with one or more thermal properties, where a value of each of the one or more thermal properties may be associated with reducing heat transfer through the insulated sleeve to below a threshold value (e.g., as compared to the tapered heating chamber 105 without the insulated sleeve). In such cases, the threshold value may be based on a temperature associated with burning a user. In some examples, the insulated sleeve may include a first set of openings over the first set of intake elements 120 and a second set of openings over the second set of intake elements 130, such that the first set of intake elements 120 and the second set of intake elements 130 may intake air while the insulated sleeve is positioned on the tapered heating chamber 105.

Particular aspects of the subject matter described herein may be implemented to realize one or more of the following potential advantages. The techniques employed by the described clean combustion stove may provide benefits and enhancements to the operation of cooking devices, including reduction of smoke production (e.g., lowering air pollution), increased accessibility (e.g., does not require electricity), increased safety of use (e.g., for use in the home around children and family), lowered costs (e.g., may be accessible to impoverished or developing countries), and increased case of operation (e.g., may not require maintenance or complex instructions). Further, the clean combustion stove may be aesthetically pleasing (e.g., visually appealing for household use), of low weight (e.g., less than 30 lbs, easily transportable), reusable, and durable.

It should be appreciated by a person skilled in the art that one or more aspects of the disclosure may be implemented to additionally or alternatively solve other problems than those described herein. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

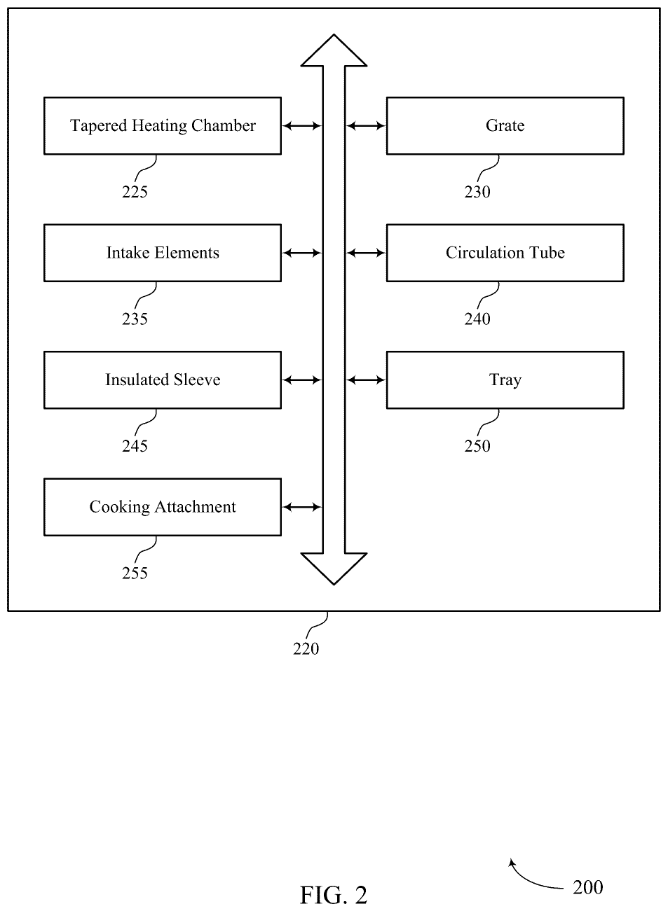

FIG. 2 shows a block diagram 200 of a clean combustion stove 220 that supports clean combustion in accordance with aspects of the present disclosure. The clean combustion stove 220, or various components thereof, may be an example of a system for performing various aspects of clean combustion as described herein. For example, the clean combustion stove 220 may include a tapered heating chamber 225, a grate 230, intake elements 235 (e.g., a first set of intake elements 235 and a second set of intake elements 235), a circulation tube 240, an insulated sleeve 245, a tray 250, a cooking attachment 255, or any combination thereof. Each of these components, or components of subcomponents thereof may interface, directly or indirectly, with one another.

The tapered heating chamber 225 may be configured to or otherwise support a means for directing heat to a centralized output of the tapered heating chamber 225. The grate 230, positioned within the tapered heating chamber 225, may be configured to or otherwise support a means for supporting a fuel source. The intake elements 235 may include the first set of intake elements 235, positioned through a wall of the tapered heating chamber 225 and below the grate 230 in a primary combustion zone, that may be configured to or otherwise support a means for intaking air from outside of the tapered heating chamber 225, wherein the primary combustion zone is configured to produce smoke via primary combustion of the fuel source. In some examples, the intake elements 235 may include the second set of intake elements 235, positioned in a secondary combustion zone located above the primary combustion zone, that may be configured to or otherwise support a means for intaking air from outside of the tapered heating chamber 225 and directing the air through the circulation tube 240. The second set of intake elements 235 may further include one or more intake tubes having a first opening through the wall of the tapered heating chamber 225 and a second opening entering the circulation tube 240. The circulation tube 240, positioned within the tapered heating chamber 225 in the secondary combustion zone above the second set of intake elements 235, may be configured to or otherwise support a means for directing air from the one or more intake tubes into the secondary combustion zone via multiple outlet holes, wherein the secondary combustion zone is configured to reduce smoke through the centralized output via secondary combustion of the fuel source.

In some examples, the circulation tube 240 may form a ring including an internal housing and an external housing, the external housing positioned to contact the wall of the tapered heating chamber 225.

In some examples, the circulation tube 240 may be configured to or otherwise support a means for evenly distributing air into the secondary combustion zone through the multiple outlet holes. In some examples, the secondary combustion is based on evenly distributing the air into the secondary combustion zone.

In some examples, the one or more intake tubes may be configured to or otherwise support a means for regulating airflow into the circulation tube 240. In some examples, the secondary combustion is based on a quantity of air fed into the circulation tube 240.

In some examples, the secondary combustion of the fuel source reduces a quantity of the fuel source below a threshold. In some examples, reducing smoke through the centralized output is based on the quantity of the fuel source being below the threshold.

In some examples, the insulated sleeve 245, external to the tapered heating chamber 225, may be configured to or otherwise support a means for reducing heat loss through the wall of the tapered heating chamber 225.

In some examples, the insulated sleeve 245 may include a first set of openings over the first set of intake elements 235 and a second set of openings over the second set of intake elements 235.

In some examples, intaking air from outside of the tapered heating chamber 225 via the first set of intake elements 235 and via the second set of intake elements 235 is based on a negative pressure produced by the primary combustion and the secondary combustion, respectively.

In some examples, the tray 250, positioned within the tapered heating chamber 225 below the grate 230, may be configured to or otherwise support a means for collecting waste produced from the fuel source during the primary combustion and secondary combustion.

In some examples, the primary combustion zone is located in a lower portion of the tapered heating chamber 225 and the secondary combustion zone is located in an upper portion of the tapered heating chamber 225.

In some examples, the cooking attachment 255, secured on top of the tapered heating chamber 225 at least partially above the centralized output, may be configured to or otherwise support a means for securing a cooking apparatus to the tapered heating chamber 225 in a path of the directed heat. In some examples, the cooking attachment is removable from the tapered heating chamber.

In some examples, a combined surface area of the multiple of outlet holes is equal to a surface area of the centralized output of the tapered heating chamber 225.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A clean combustion cooking device, comprising:
a tapered heating chamber configured to direct heat to a centralized output of the tapered heating chamber;
a grate positioned within the tapered heating chamber, the grate configured to support a fuel source;
a first set of intake elements positioned through a wall of the tapered heating chamber and below the grate in a primary combustion zone, the first set of intake elements configured to intake air from outside of the tapered heating chamber, wherein the primary combustion zone is configured to produce smoke via primary combustion of the fuel source;
a second set of intake elements in a secondary combustion zone located above the primary combustion zone comprising one or more intake tubes having a first opening through the wall of the tapered heating chamber and a second opening entering a circulation tube, the second set of intake elements configured to intake air from outside of the tapered heating chamber and direct the air through the circulation tube; and
the circulation tube positioned within the tapered heating chamber in the secondary combustion zone above the second set of intake elements comprising a plurality of outlet holes configured to direct air from the one or more intake tubes into the secondary combustion zone, wherein the secondary combustion zone is configured to reduce smoke through the centralized output via secondary combustion of the fuel source.

2. The clean combustion cooking device of claim 1, wherein the circulation tube is configured to form a ring comprising an internal housing and an external housing, the external housing positioned to contact the wall of the tapered heating chamber.

3. The clean combustion cooking device of claim 1, wherein the circulation tube is configured to evenly distribute air into the secondary combustion zone through the plurality of outlet holes, and wherein the secondary combustion is based at least in part on evenly distributing the air into the secondary combustion zone.

4. The clean combustion cooking device of claim 1, wherein the one or more intake tubes are configured to regulate airflow into the circulation tube, and wherein the secondary combustion is based at least in part on a quantity air fed into the circulation tube.

5. The clean combustion cooking device of claim 1, wherein the secondary combustion of the fuel source reduces a quantity of the fuel source below a threshold, and wherein reducing the smoke through the centralized output is based at least in part on the quantity of the fuel source being below the threshold.

6. The clean combustion cooking device of claim 1, further comprising:
an insulated sleeve external to the tapered heating chamber, the insulated sleeve configured to reduce heat loss through the wall of the tapered heating chamber.

7. The clean combustion cooking device of claim 6, wherein the insulated sleeve comprises a first set of openings over the first set of intake elements and a second set of openings over the second set of intake elements.

8. The clean combustion cooking device of claim 1, wherein intaking air from outside of the tapered heating chamber via the first set of intake elements and via the second set of intake elements is based at least in part on a negative pressure produced by the primary combustion and the secondary combustion, respectively.

9. The clean combustion cooking device of claim 1, further comprising:
a tray positioned within the tapered heating chamber below the grate, the tray configured to collect waste produced from the fuel source during the primary combustion and the secondary combustion.

10. The clean combustion cooking device of claim 1, wherein the primary combustion zone is located in a lower portion of the tapered heating chamber and the secondary combustion zone is located in an upper portion of the tapered heating chamber.

11. The clean combustion cooking device of claim 1, further comprising:
a cooking attachment secured on top of the tapered heating chamber at least partially above the centralized output, the cooking attachment configured to secure a cooking apparatus to the tapered heating chamber in a path of the directed heat.

12. The clean combustion cooking device of claim 11, wherein the cooking attachment is removable from the tapered heating chamber.

13. The clean combustion cooking device of claim 1, wherein a combined surface area of the plurality of outlet holes is equal to a surface area of the centralized output of the tapered heating chamber.
